(19) United States
(12) Patent Application Publication
(10) Pub. No.: US 2015/0302177 A1
(43) Pub. Date: Oct. 22, 2015

(54) DRUG DISPENSING SYSTEM

(71) Applicant: NEWICON OY, Kuopio (FI)

(72) Inventors: Ossi Parviainen, Kuopio (FI); Jori-Matti Savolainen, Polja (FI)

(21) Appl. No.: 14/441,166

(22) PCT Filed: Nov. 6, 2013
(86) PCT No.: PCT/FI2013/051047

§ 371 Date: May 6, 2015

(30) Foreign Application Priority Data
Nov. 7, 2012 (FI) 20126169

(51) Int. Cl. G06F 19/00

(52) U.S. Cl. CPC G06F 19/3462

(57) ABSTRACT

In a drug dispensing system, data about the medication of a patient is received and used for generating drug dose data. The drug dose data includes data on the drug dose to be administered at a time. Drug balances can be maintained on the basis of the drug dose data. The drug storage of the hospital can be controlled by maintaining drug balances of a first drug storage in a computerized storage control system, and by updating the drug balances of the first drug storage on the basis of a drug delivery from the first drug storage to a second drug storage, and also by maintaining the drug balances of this second drug storage and by updating the drug balances of the second drug storage on the basis of both the drug delivery and the dispensing of the drug from the second drug storage.

### FIELD OF THE INVENTION

The invention relates to drug dispensing systems, and in particular it relates to systems by which drugs can be dispensed to end users, such as patients in a hospital. The invention also relates to a method and a computer program product for dispensing drugs, as well as the maintenance of drug balances.

### BACKGROUND OF THE INVENTION

Drugs to be administered to patients at hospitals and health centres are usually dispensed once in 1 to 7 days. The dispensing is performed in such a way that the dispensing nurse retrieves the data and doses of the drugs to be administered to each patient from a patient data system, and doses them in dispensing cups to be placed ready on a tray or drug organizer. The same drug organizer or tray may contain the drugs for several patients, for example in such a way that the drugs for the patients in the same patient room, or the drugs for the patients with the same disease in the same department, for one or several days, are dispensed on a single medicine organizer or tray. In each dispensing cup, the drugs are dosed in such a way that the drugs for one patient are usually divided into different dispensing cups according to their time of administration. In other words, a single medicine organizer or tray may contain dozens of drug doses, and therefore it has to be clearly marked on the dispensing cups to whom the drugs in each dispensing cup are intended, and the time when they are to be administered to this patient.

The dispensing of drugs in a hospital ward is often performed manually from the drug stock of the ward in the above described way. When a drug runs out or is running short in the drug stock of the ward, more drug packages are ordered from the hospital pharmacy (hospital drug storage), for dispensing. As a result of human activity, mistakes may occur in the dispensing and dosing of drugs, and moreover, drugs may be lost for other reasons.

Therefore, a solution is needed for improving the reliability of the dispensing of drugs.

### SUMMARY

Now, an improved method, system and computer program product have been invented for the dispensing of drugs, for alleviating the problems described above. The independent claims present different aspects of the invention, and the dependent claims present different embodiments of the invention.

The invention relates to a drug dispensing system and a drug dispensing method. In the system, information about the medication of a patient is received and used for generating drug dose data. The drug dose data includes data on the drug dose to be administered at one time, and it is thus smaller than the quantity of the drug contained in a single drug package, i.e. a dispensing unit; in other words, several drug doses are obtained from a single drug package. The dispensing of the drug can be controlled on the basis of the drug dose data, and drug balances can be maintained on the basis of the drug dose data. In this way, the maintenance of drug balances can be extended from the hospital pharmacy to the ward, and it can be implemented at the accuracy of even a single dose unit (e.g. a pill or a drug volume administered in millilitres). Thus, the drug stock of the hospital can be managed by maintaining the drug balances of a first drug storage in a computerized stock control system and updating the drug balances of the first drug storage on the basis of a drug delivery from the first drug storage to a second drug storage, and by also maintaining the drug balances of this second drug storage and updating the drug balances of the second drug storage on the basis of both the drug delivery and the dispensing of the drug from the second drug storage.

When the accuracy of the dispensing of drugs is guided and possibly checked in the above described way at the hospital ward, it is also possible according to the invention to maintain stock balances on the quantities of drugs in hospital wards. This may make it possible to maintain more accurate balances on the whole drug stock of the hospital and, for example, to reduce the quantity of drugs to be purchased to the hospital. Furthermore, pharmaceutical safety may be improved as the quantities of drugs can be managed better and the dispensing of drugs is guided more accurately, wherein the frequency of human errors decreases. The dispensing of drugs is performed on the basis of the prescriptions of the patients, wherein the stock control of the whole system may be based on the prescriptions of the patients.

According to a first aspect, a drug dispensing system is provided, which system comprises means for receiving information about the medication of a patient; means for generating at least one item of drug dose data on the basis of said information on the medication, wherein the drug dose data comprises the drug dose to be administered at one time, the drug dose being smaller than the quantity of drug contained in a single drug package; means for guiding the dispensing of the drug on the basis of said drug dose data; and means for updating the drug balance on the basis of said dispensing. The system may comprise a first and a second drug storage, and there may be means for placing a drug order from said first drug storage to said second drug storage according to said medication data, means for updating the drug balance of said second drug storage on the basis of said drug order, and means for updating the drug balance of said first drug storage on the basis of said drug order.

In an embodiment, the system comprises means for making a drug package available to a user on the basis of said drug dose data. In an embodiment, the system comprises means, for example bar code reading means, for automatic reading of package information from said drug package, for example by reading a bar code from the drug package; and means for comparing said package information with said information on the medication and/or said drug dose data.

According to a second aspect, a computer program product is provided, which comprises computer program code stored on a computer readable medium, the computer program code being configured, when run by at least one processor, to make the system or the device receive the information on the medication of a patient via the computer interface; to generate at least one item of drug dose data on the basis of said information on the medication, where the drug dose data comprises the drug dose to be administered at one time, the drug dose being smaller than that the quantity of medicine contained in a single drug package; to generate a message on the computer interface, for guiding the dispensing of said drug on the basis of said drug dose data, said message comprising said drug dose data; and to update the drug balance on the basis of said drug dose data.

In an embodiment, the computer program product comprises a computer program code which is configured to make the device or system, on the basis of the drug dose data, generate a drug balance message for maintaining or updating the drug balance; and to make said drug balance message available on the computer interface.

In an embodiment, receiving the information on the medication above comprises receiving the information from another computer system via the computer interface. In an embodiment, receiving the information on the medication above comprises receiving the information from the user of the computer via the computer interface, said computer interface being the user interface of the computer. In an embodiment, forming said drug dose data above comprises selecting the drug package on the basis of the drug storage information, and generating information on the quantity of drug units.

According to a third aspect, a method is provided for managing a drug storage, the method comprising maintaining the drug balances of a first drug storage in a computerized stock control system; and updating said drug balances of the first drug storage on the basis of a drug order, said drug order relating to the delivery of a drug to a second drug storage; maintaining the drug balances of said second storage; updating said drug balances of the second drug storage on the basis of said drug order; receiving drug dose data relating to the dispensing of a drug from said second drug storage, the dispensing of the drug comprising determining the drug dose to be taken at one time, the drug dose being smaller than the quantity of medicine contained in a single drug package; and updating said drug balances of the second drug storage on the basis of said drug dose data.

According to a fourth aspect, use of drug dose data is provided in the computerized management of drug balances in a hospital, where said drug dose data includes data on the medication administered to a patient at the accuracy of one pill.

### FIGURES

In the following, the function of the different aspects and embodiments will be described by way of example with reference to the drawings, in which

FIG. 1 shows the operation of the drug dispensing system in an example;

FIG. 2a shows a block chart of the drug dispensing system in an example;

FIG. 2b shows a block chart of a drug dispensing device in an example;

FIG. 3a shows a flow chart on the operation of a drug dispensing system in an example;

FIG. 3b shows a flow chart on the method for management of a drug storage in an example; and

FIGS. 4a, 4b and 4c show a drug dispensing device according to an example.

### DESCRIPTION OF THE INVENTION

The following is a description of the function of different aspects and embodiments of the invention in a hospital environment. However, it is obvious that the invention is not limited to the hospital environment only, especially to a specific type of hospital environment, or to a specific drug dispensing system, but the invention can find applications widely anywhere where the handling of drugs, drug-like products, such as vitamins, or medical samples is to be improved.

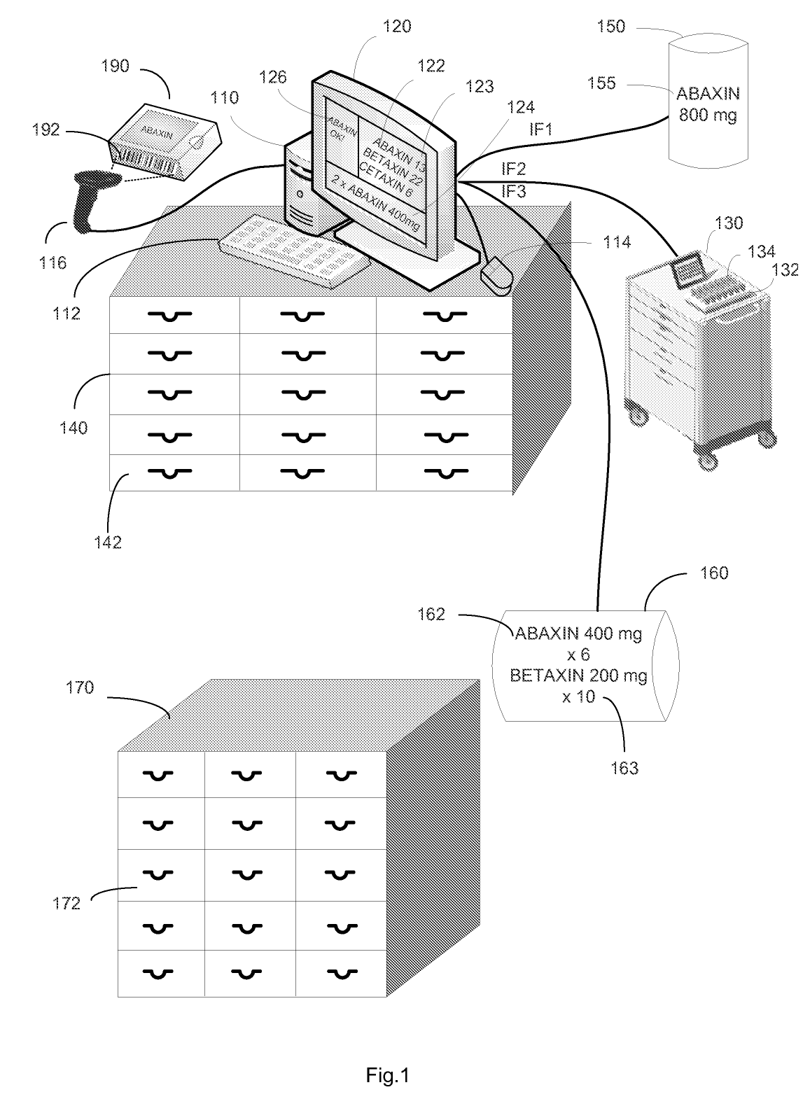

FIG. 1 shows the operation of the drug dispensing system in an example. The drug dispensing system comprises one or more computers 110 of the drug dispensing system, which computer may be equipped with a user interface for the user, comprising e.g. a keyboard 112, a mouse 114, a bar code reader or another reader device 116, and a display 120. In the system, information 122 on the drugs and drug balances 123 can be maintained in the computer 110 by storing them in the memory of the computer, from which the data can be retrieved e.g. to be displayed on the display 120 to the user and/or to be transmitted via another computer interface of the computer to another computer. It should be noted that the computer 110, which can be e.g. a computer for the drug storage of a hospital ward, can be used to maintain drug balances at a high accuracy, for example at the accuracy of one drug dose unit, such as a pill or a liquid volume (e.g. a millilitre or 15 ml). In FIG. 1, there are 13 pills of a drug called Abaxin, 22 pills of a drug called Betaxin, and 6 pills of a drug called Cetaxin in the drug storage of the ward. The maintenance of this accurate balance is possible, because the dispensing of drugs from the drug storage 140 is guided in the drug dispensing system. This guidance and the related maintenance of drug balances will be described in the following.

The computer 110 of the drug dispensing system may comprise one or more computer interfaces IF1, IF2, IF3. The computer 110 may be connected via the interface IF1 to e.g. a patient data system 150 which may contain data on the medication of the patients in the ward (in the figure, e.g. on the ABAXIN medication 155 of a patient). This medication data 155 can be received in the computer 110. However, the medication data can also be received from a user, for example via the user interface in such a way that the user can enter patients' drug prescriptions in the system. In the computer 110 or in another system connected to it, drug dose data 124 can be generated from the medication data, for guiding the dispensing of the drug. For this, it is possible to determine, for example, how many tablets (pills) with a given strength of the drug have to be taken. For example, if 800 mg of the drug Abaxin have been prescribed for the patient, the system may retrieve from the memory the information that the drug Abaxin is available in pills of 400 mg in the drug storage of the ward, whereby the generated drug dose data is that 2 pills of the drug Abaxin have to be dispensed, and the drug strength of the pills is 400 mg. Also, the dispensing of liquid drugs can be guided, for example by instructing that 3 ml of a drug should be drawn up from an ampoule into a syringe when the syringe is prepared for use. As described above, the correct and accurate dosage of the drug is important for efficient care and safety. In the invention, it has been found that by accurate dispensing and control of drugs, it is also possible to maintain stock balances more accurately than has been possible before.

After the drug dose data 124 has been generated, it can be used to guide the dispensing of the drug, for example by some or all of the following operations. The drug dose data 124 can be presented to the user (for example a nurse) on the display 120. This has the benefit that when dispensing the drug, the user can clearly see which drug should be taken and how many drug units should be dosed. This is an improvement compared to dispensing the drugs directly on the basis of the information on the patient's medication, and may reduce the frequency of human errors, for example miscalculations.

By means of the bar code reader 116, by reading the bar code 192 of the drug package 190, it is possible to check that the drug package contains the correct drug and the strength of the drug units is correct; in other words, that the drug package selected by the user corresponds to the drug dose data 124. If the user has selected an incorrect drug package 190, a warning can be displayed, and after the correct drug package 190 has been selected, a confirmation 126 of the correct selection can be displayed. This may prevent, for example, the selection of an incorrect drug or a drug of an incorrect strength. The computer 110 can also be used for controlling the operation of the drug storage 140 in such a way that a compartment 142 of the drug storage is opened from a locked state, and thus the user has access to drug packages in the opened compartment 142 only. Such a function may be necessary, for example, in the case of narcotic drugs, wherein the device can be configured to operate for example in such a way that only authorized persons have access to the narcotic drugs; in other words, they are kept in locked compartments out of reach of other users. When dispensing a narcotic drug, the respective compartment can be unlocked for the time of dispensing the drug. The drug storage may also have a function of making the drug package available to the user, for example by means of a robot, and returning the drug package to the storage after the dispensing.

The computer 110 or another device with drug dose data may also control the operation of a drug delivery cart 130 and/or a drug organizer 132 via a computer interface IF2, for accurate and correct dispensing of the drugs. On the basis of the drug dose data, a light can be lit below or next to the dispensing cups or units 134 in the drug organizer, corresponding to each drug dose to be dispensed, wherein it is easy for the user to place the drug dose in the correct dispensing cup or unit 134. The dispensing can also be guided, for example, on a display. The system may also produce information on to whom and when each drug dose should be administered. Such a procedure can improve the correctness of the dispensing of drugs and improve the effectiveness of the pharmaceutical therapy.

In this way, the quantity of drugs ending up in the dispensing cups or units is also accurately known, which makes it possible to maintain stock balances 123. In practice, this can be done by decreasing the balances of the ward drug storage each time a user has dispensed one drug dose. In this way, it is possible to know when a drug is running short in the ward drug storage 140, and to place an order at the hospital pharmacy drug storage 170 where the drugs can be stored, for example, in boxes 172 or in an automated robot-assisted drug storage. The drug balances 163 of the drugs 162 in the hospital pharmacy can be maintained on the basis of the placed orders in the drug management system 160 of the pharmacy. For example, if an order is placed for two packages of the drug Abaxin 400 mg to the ward drug storage, the balance of the drug storage of the hospital pharmacy is decreased by two dispensing units (two drug packages) or by a number of dose units (for example, number of tablets) corresponding to two drug packages, and the balance of the ward drug storage is increased by two drug packages or by a number of dose units (for example, number of tablets) corresponding to two drug packages, respectively. Consequently, for the drug Abaxin 400 mg, the drug balance of the entire hospital is thus decreased when the drug is dispensed. The advantage of this is the fact that it is possible to know the total balance for Abaxin 400 mg in the whole hospital more accurately than in the prior situation where only the accurate quantities of drugs in the hospital pharmacy were known. Accurate data on the stock balance of the entire hospital is useful in that it is not necessary to order more drugs for the hospital than needed, and therefore the drugs do not expire in vain.

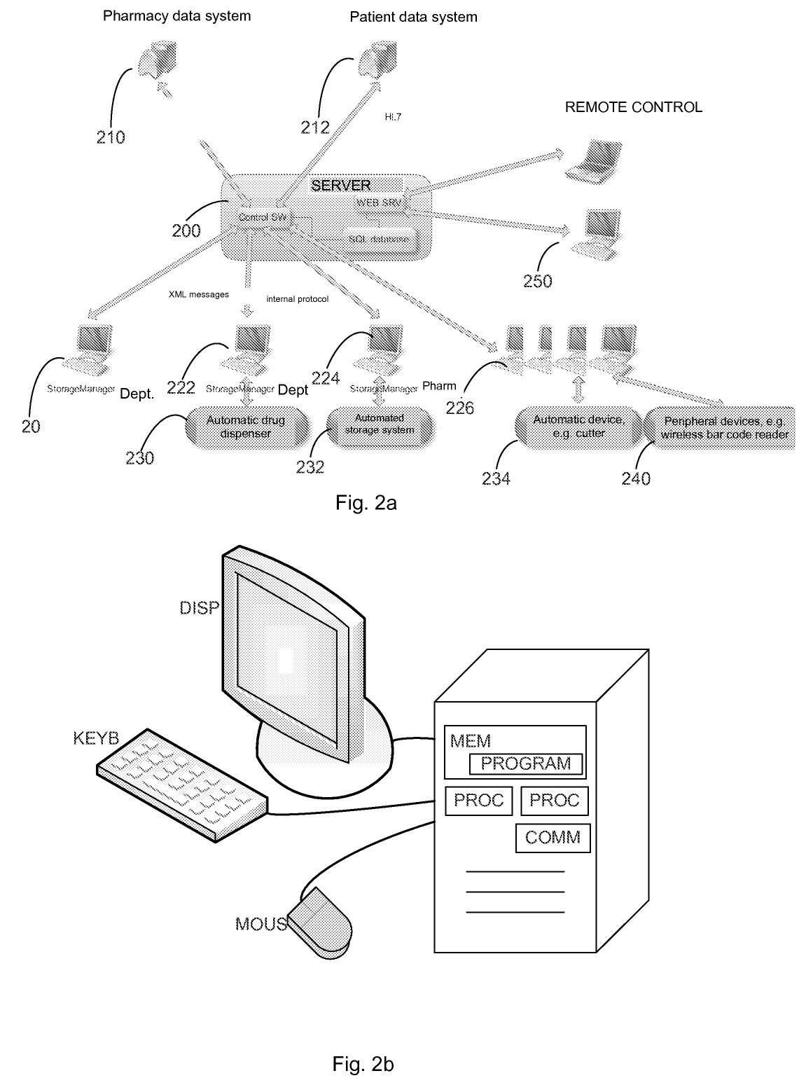

FIG. 2a shows a block chart of a drug dispensing system in an example. The drug dispensing system comprises one or more servers 200 for controlling the dispensing of drugs. The server may comprise control program code CONTROL SW, a database SQL DATABASE, and a web server WEB SRV.

The database may comprise data on drugs and medication, stock balances, and other information. The web server may provide remote control computers 250 with a computer interface for controlling the server.

The server and particularly its programs may be connected via the computer interfaces to the pharmacy data system 210 for maintaining drug balances, to a patient data system 121 for receiving information on the medication of the patients, and to ward drug dispensing systems 220, 222 and 224, as well as to other systems 226. These different systems may communicate with each other either directly or via the server 200. For example, the pharmacy drug balance management system 224 and the ward drug balance management system 220, 222 can transmit balance data to each other in this way. As described above, the ward drug dispensing system may comprise an automatic drug dispenser 230 and the pharmacy may correspondingly comprise an automated storage and retrieval system 232 for facilitating and securing the delivery of drugs. Other automation, such as operating theatre automation 234, and peripheral devices 240 can also be connected to the devices of the system. It is understandable that with the development of technology, various local drug dispensing systems or other devices (of e.g. the ward or another nursing unit) may be included in the system. There is no limit to their number as such. The drug dispensing system of FIG. 2a can provide the advantage of making the management of the hospital drug stock more efficient by providing an efficient and accurate stock management system.

FIG. 2b shows a block chart of a drug dispensing device of a drug dispensing system in an example. The device may comprise a central processing unit with a memory MEM, and this memory may comprise a program code PROGRAM for controlling the operation of one or more processors PROC so that the device runs or controls the operation according to the invention. The device may communicate with other devices via a communication module COMM. The device may communicate with a user via a user interface which may comprise, for example, a display DISP, a keyboard KEYB, and a mouse MOUS.

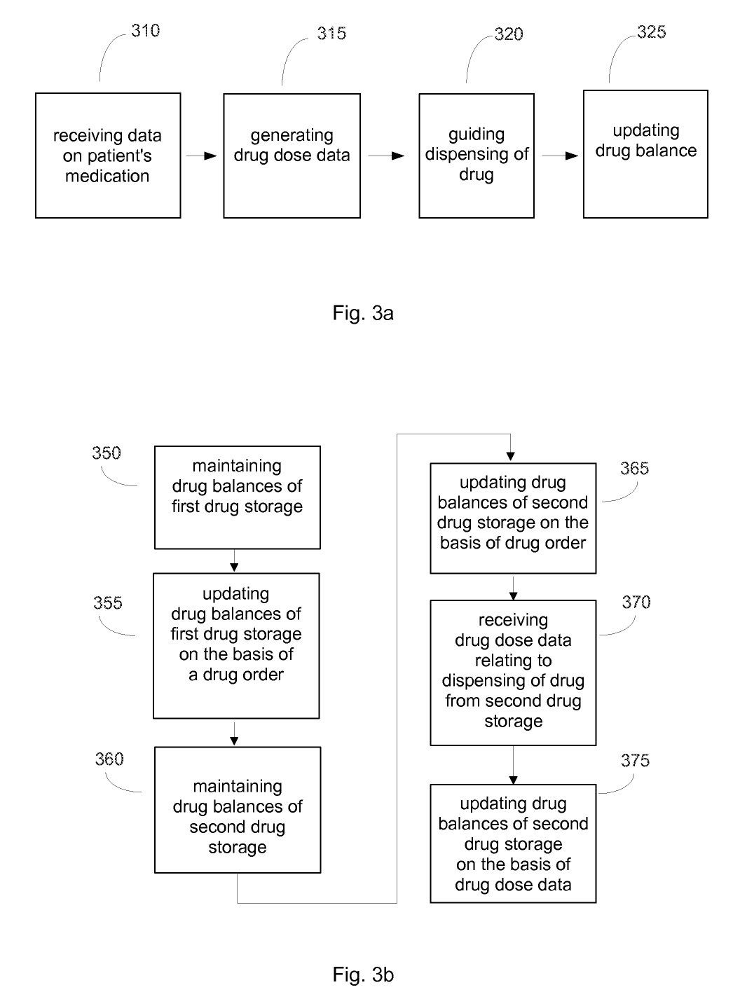

FIG. 3a shows a flow chart on the operation of a drug dispensing system in an example. In step 310, data on the medication of a patient is received, for example, from a patient data system or from a user. In step 315, at least one item of drug dose data is generated on the basis of the data on the medication, as described above. Here, the drug dose data comprises the drug dose to be taken at one time, and this drug dose is smaller than the quantity of the drug contained in a single drug package (delivery unit). For example, 2 pills from one drug package containing 20 pills can be dispensed to be administered to a patient. In step 320, the dispensing of the drug is guided on the basis of the drug dose data, for example by displaying accurate data on the drug to be dispensed to the user, as described above, and/or by making sure that the user has picked up the correct drug package by reading the bar code of the package. In step 325, the drug balance is updated on the basis of the drug dose data, for example by decreasing the balance of the ward drug storage by the number of pills dispensed. In the method, it is also possible to make the drug package available to a user on the basis of said drug dose data, and/or to automatically read package data from the package for verifying the correct package by comparing it with the data on the medication, for example by reading a bar code from the drug package.

FIG. 3b shows a flow chart on the method of managing a drug storage in an example. By way of example, in step 350 it is possible to maintain drug balances of a first drug storage in a computerized stock management system, for example the stock management system of a hospital pharmacy. In step 355, these drug balances of the first drug storage can be updated on the basis of a drug order, the drug order relating to the delivery of a drug to a second drug storage, for example the drug storage of a ward. In other words, when drugs are delivered from the hospital pharmacy to the drug storage of a ward, these are subtracted from the drug balances of the hospital pharmacy. In step 360, the drug balances of a second drug storage, for example the balances of a ward drug storage, are maintained. When a drug has been delivered from the first drug storage (pharmacy) to the ward, the drug balances of the second drug storage are updated on the basis of this drug order in step 365. In step 370, drug dose data is received, relating to the dispensing of the drug from this second drug storage, the dispensing of the drug comprising determining the drug dose to be administered at one time, the drug dose being smaller than the quantity of drug contained in one drug package, as described above. Consequently, pieces of drug dose data are received on the basis of dispensing in the ward for updating the drug balances, which is performed in step 375.

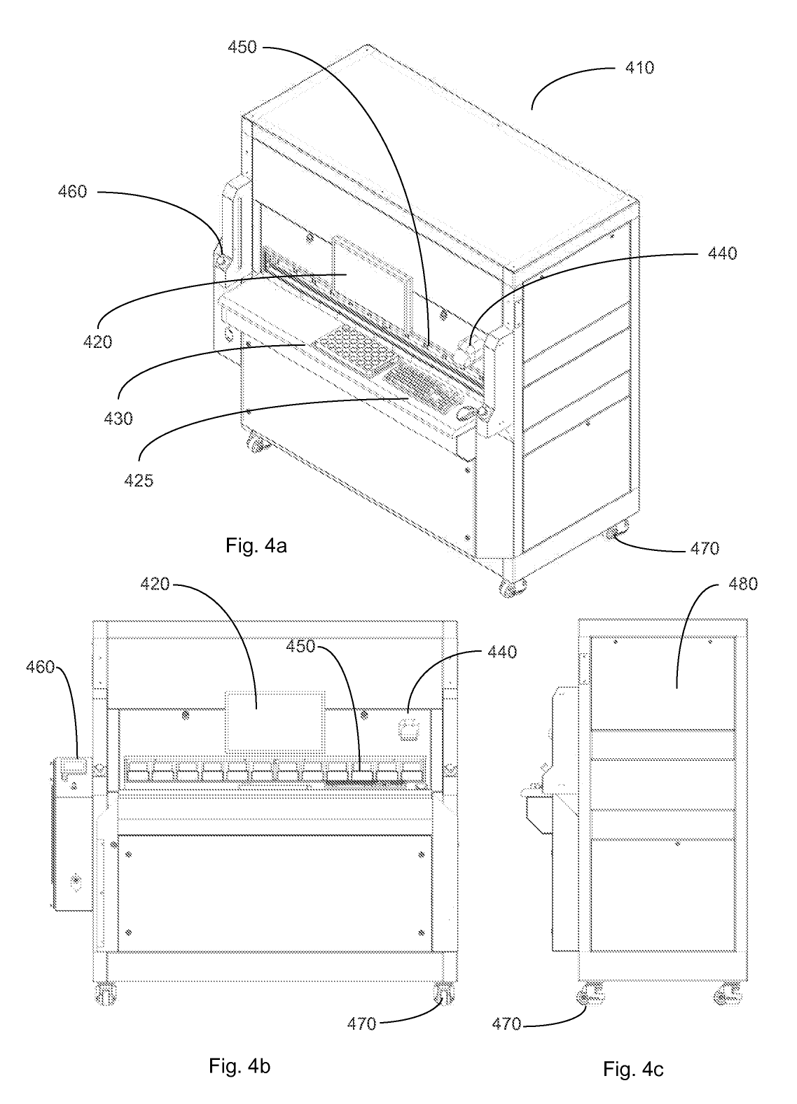

FIGS. 4a, 4b and 4c illustrate a drug dispensing device 410 according to an example, in which the drugs are made available to the user by means of a drug package carousel 450. The device may be provided with a user interface, for example a display 420 and a keyboard and a mouse 425. On the user interface, the user sees the data of the drugs to be dispensed, and instructions for dispensing the drugs can also be given on the display, for example if liquid drugs have to be dosed in millilitres or if the drug requires mixing. If authorized, the user can also enter a drug prescription in the system, via the user interface. For the dispensing of drugs, a tray 430 can be used, as described above, and the tray or the drug dispensing device can be equipped with means (e.g. a light) for indicating the correct drug dispensing unit to the user. The drug dispensing device may be equipped with a bar code reader 440 for identifying/securing the correct drug package, as described above. The drug packages can be brought within the reach of the user by a carousel or another type of delivery system 450. This has the advantage that the device produces the correct drug package, and no time is wasted on selecting the drug package. The drug dispensing device may also comprise a control unit and a motor 460 for the carousel or delivery system, for controlling the delivery of drugs, wheels or other means of locomotion 470 for moving the drug dispensing device, and tight walls 480 and a hatch for preventing unauthorized access to the inside of the device.

It should be noted that the selections made in the invention for guiding the dispensing of drugs and for maintaining drug balances are not self-evident. For example, the keeping of drug balances in an environment of prior art on the level of single pills or even in a ward would easily increase the workload to a significant extent, which is why such a system would not necessarily be worthwhile of implementing even if it were invented. However, this problem can be alleviated by another element of the present invention, namely by computerized determination of drug dose data and guiding of drug dispensing, and automatic maintenance of balances on the basis of it. In this way, by combining the different aspects, an efficient system is surprisingly obtained.

The embodiments of the invention can be implemented in part or in whole by means of a computer program code, which computer program code is provided in a memory or in a computer readable medium, and makes the device or system execute functions according to the embodiments of the invention. For example, a computer program code can be stored in the memory of the drug dispensing device for guiding the dispensing of drugs, for keeping drug balances and for receiving and processing data on the medication of patients. The hospital pharmacy system may comprise a computer program code for keeping drug balances and for receiving messages from drug dispensing devices, whereby the computer program code of the pharmacy system may make it possible to keep stock balances at the accuracy of one pill. The computer program code can be provided in a computer readable format in the data medium, or it can be in the form of a circuit, for example a circuit applying a microcode or a circuit implemented as gate logic. The computer program code and the circuit electronics can also be used in combination for implementing the embodiments of the invention.

A drug dispensing system may e.g. comprise at least one processor and memory, and computer program code residing in the memory, the computer program code being configured, when executed on the at least one processor, to cause the system to carry out the method according to as described in any of the claim 1 to 10 or 13, or on the description above, for example relating to FIGS. 3a and 3b.

As an example, a drug dispensing system may comprise a first drug storage, a second drug storage connected to a first drug storage, at least one processor and memory, and computer program code residing in the memory, the computer program code being configured, when executed on the at least one processor, to cause the system to receive data (155) on the medication of a patient generate at least one item of drug dose data (124) on the basis of said medication data (155), said item of drug dose data (124) comprising the drug dose to be administered at one time, at the accuracy of a dose unit, the drug dose being smaller than the quantity of drug contained in one drug package, guide the dispensing of the drug on the basis of said item of drug dose data (124), update the drug balance (123) of said second drug storage (124) on the basis of said dispensing, place a drug order in said first drug storage (170) according to said medication data (155), said drug order relating to the delivery of the drug to said second drug storage (140), update the drug balance (123) in said second drug storage (140) on the basis of said drug order and transmit data according to said drug order for updating the drug balance (163) of said first drug storage (170).

It is thus obvious that the present invention is not limited to the above described embodiments only, but it can be modified and it can be present in different forms in different applications, as set forth in the appended claims.

1-11. (canceled)

12. A drug dispensing system, the system comprising a first drug storage and a second drug storage,
said second drug storage connected to said first drug storage over a computer interface, the system comprising at least one processor and memory, and computer program code residing in said memory, said computer program code being configured, when executed on said at least one processor, to cause the system to:
receive, in the second drug storage, data on the medication of a patient;
generate, in the second drug storage, at least one item of drug dose data on the basis of said medication data, said item of drug dose data comprising the drug dose to be administered at one time, at the accuracy of a dose unit, the drug dose being smaller than the quantity of drug contained in one drug package;
guide, in the second drug storage, dispensing of the drug on the basis of said item of drug dose data, said guiding dispensing of the drug comprising determining the drug dose to be administered at one time, the drug dose being smaller than the quantity of drug contained in one drug package residing in the second drug storage;
update, in the second drug storage, the drug balance of said second drug storage on the basis of said dispensing;
place a drug order from the second drug storage to said first drug storage, said drug order relating to delivery of the drug to said second drug storage;
update the drug balance in said second drug storage on the basis of said delivery;
transmit data according to said delivery from the second drug storage to the first drug storage for updating the drug balance of said first drug storage.

13. A method for controlling a drug storage, the method comprising:
providing data according to a drug order from a second drug storage to a first drug storage for carrying out a delivery of drugs from said first drug storage to said second drug storage, and for updating drug balances on the basis of the delivery;
maintaining drug balances of said second drug storage;
updating the drug balances of said second drug storage on the basis of said delivery;
receiving drug dose data relating to guiding dispensing of the drug from said second drug storage, the guiding dispensing of the drug comprising determining the drug dose to be taken at one time, the drug dose being smaller than the quantity of drug contained in one drug package residing in said second drug storage; and
updating said drug balances of the second drug storage on the basis of said dispensing.

14. A drug dispensing system comprising a first drug storage, a second drug storage connected to a first drug storage, the system comprising at least one processor and memory, and computer program code residing in said memory, said computer program code being configured, when executed on said at least one processor, to cause the system to:
receive data on the medication of a patient;
generate at least one item of drug dose data on the basis of said medication data, said item of drug dose data comprising the drug dose to be administered at one time, at the accuracy of a dose unit, the drug dose being smaller than the quantity of drug contained in one drug package;
guide the dispensing of the drug in the second drug storage on the basis of said item of drug dose data said guiding dispensing of the drug comprising determining the drug dose to be administered at one time, the drug dose being smaller than the quantity of drug contained in one drug package residing in the second drug storage;
update the drug balance of said second drug storage on the basis of said dispensing;
place a drug order by providing information according to said drug order from said second drug storage to said first drug storage, said drug order relating to delivery of the drug from said first drug storage to said second drug storage;
update the drug balances in said first and second drug storage on the basis of said delivery.

15. (canceled)

16. The method according to claim 13, said method further comprising:
making the drug package available to a user on the basis of said item of drug dose data.

17. The method according to claim 13, said method further comprising:
automatic reading of package data from said drug package; and
comparing said package data with said medication data and/or said item of drug dose data.

18. The method according to claim 13, wherein receiving the medication data comprises receiving the data via a computer interface from another data system.

19. The method according to claim 13, wherein receiving the medication data comprises receiving the data via a computer interface from the user of a computer, said computer interface being the user interface of the computer.

20. The method according to claim 13, wherein generating the drug dose data comprises selecting a drug package on the basis of drug storage data, and generating data on the quantity of drug units.

21. The system according to claim 14, said computer program code configured to cause the system to:
make the drug package available to a user on the basis of said item of drug dose data.

22. The system according to claim 14, said computer program code configured to cause the system to:
automatically read package data from said drug package; and
compare said package data with said medication data and/or said item of drug dose data.

23. The system according to claim 14, wherein receiving the medication data comprises receiving the data via a computer interface from another data system.

24. The system according to claim 14, wherein receiving the medication data comprises receiving the data via a computer interface from the user of a computer, said computer interface being the user interface of the computer.

25. The system according to claim 14, wherein generating the drug dose data comprises selecting a drug package on the basis of drug storage data, and generating data on the quantity of drug units.

26. A drug dispensing system according to claim 14, said computer program code configured to cause the system to:
receive, in said first drug storage, a drug order from said second drug storage, said drug order relating to the delivery of the drug to said second drug storage;
receive, in said first drug storage, data according to said delivery for updating the drug balance of said first drug storage.

27. A computer program product, comprising a computer program code stored in a non-transitory computer readable medium, the computer program code being configured, when read by at least one processor, to cause a system or a device to:
receive data on the medication of a patient via a computer interface;
generate at least one item of drug dose data on the basis of said medication data, said item of drug dose data comprising the drug dose to be administered at one time, at the accuracy of a dose unit, the drug dose being smaller than the quantity of drug contained in one drug package;
generate a message on the computer interface in a second drug storage for guiding dispensing of the drug on the basis of said item of drug dose data, said message comprising said item of drug dose data, and said guiding dispensing of the drug comprising determining the drug dose to be administered at one time, the drug dose being smaller than the quantity of drug contained in one drug package residing in the second drug storage;
update drug balance of said second drug storage on the basis of said dispensing;
place a drug order by providing information according to said drug order from said second drug storage to a first drug storage, said drug order relating to delivery of the drug to said second drug storage;
update the drug balance of said first and second drug storage on the basis of said delivery.

28. The computer program product according to claim 27, comprising a computer program code configured to cause a device or a system to:
generate a drug balance message on the basis of the drug dose data, for maintaining or updating the drug balance; and
make said drug balance message available on the computer interface.

29. The product according to claim 27, wherein receiving the medication data comprises receiving the data via a computer interface from another data system.

30. The product according to claim 27, wherein receiving the medication data comprises receiving the data via a computer interface from the user of a computer, said computer interface being the user interface of the computer.

31. The product according to claim 27, wherein generating the drug dose data comprises selecting a drug package on the basis of drug storage data, and generating data on the quantity of drug units.
